(19) United States
(12) Patent Application Publication
(10) Pub. No.: US 2004/0011187 A1
(43) Pub. Date: Jan. 22, 2004

(54) Method and system for group-composition in internet, and business method therefor

(76) Inventor: Kyu Jin Park, Kyungki-do (KR)

Correspondence Address: Charles F Burpee, Warner Norcross & Judd, 900 Fifth Third Center, 111 Lyon Street N W, Grand Rapids, MI, 49503-2487, US

(21) Appl. No.: 10/297,350

(22) PCT Filed: May 31, 2001
(86) PCT No.: PCT/KR01/00923

(30) Foreign Application Priority Data
Jun. 8, 2000 (KR) 2000/341258

(51) Int. Cl. A63H 5/00; G10H 7/00; G04B 13/00

(52) U.S. Cl. 84/609

(57) ABSTRACT

A common music composition method using the internet, its system, and its business application method are disclosed, in which any one of the general song components such as song words, melody and background melody is sent to a server, and the rest of the composition components are received so as to openly evaluate them, thereby commonly creating the songs. Thus, new talented music composers can be developed and grown, and the created songs can be auction-sold to agencies. The music composition method using the internet includes the following steps. That is, a connection request is inputted from a client PC, a particular component is selected from the requisite data such as song words, melody and background melody of a server, and a data of the requested music component is outputted by the server to the client PC (first step). The music components as requested by the client PC are displayed onto a screen (second step). A data of the music components as created by the user through the client PC is inputted (third step). The user-selected music component is synthesized with the music data of the third step (fourth step).

### FIELD OF THE INVENTION

The present invention relates to a common music composition method using the internet, its system, and its business application method. More specifically, the present invention relates to a common music composition method using the internet, its system, and its business application method, in which any one of the general song components such as song words, melody and background melody is sent to a server, and the rest of the composition components are received so as to openly evaluate them, thereby commonly creating the songs. Thus, new talented music composers can be developed and grown, and the created songs can be auction-sold to agencies.

### BACKGROUND OF THE INVENTION

Many people like music as taste or for profession, but it is not easy to become a music composer. One of the reasons is that the song words, the melody and the background melody belong to a difficult professional field, and therefore, knowledge and skill for the music composition and arrangement have to be preceded. The knowledge and skill on such music composition and arrangement can be obtained only through education at school or at institute, and therefore, the general people cannot approach this professional field.

There are the cases that the general people can create song words and melodies by their instant inspirations and the innate talents, these being relatively easy to create. However, their systematic professional knowledge and skill are insufficient, and therefore, their creations cannot reach the completion, but are renounced in the midway. Further, there are the cases that the general people are assisted by professional music composers, but in these cases, the creations are stolen frequently.

Owing to the progress in the software and internet, there are the services by which the general people can compose melodies on the online. However, most of the services are focusing on the composition of melodies, and therefore, the general people cannot surpass the limit of hobby. Further, there is provided a software in which if a melody is composed, then a background melody is furnished. However, in this also, a professional high level performance cannot be expected.

Thus due to the shortage of the professional knowledge on the song words, melodies and background melody, the general people cannot compose a song even if they have a talent, and therefore, they cannot contribute to the progress of music. Further, the disc manufacturing companies also have to resort to the professional composers, and therefore, the demand for diversified kinds of discs cannot be met, with the result that the narrowing of the disc market is self-created.

### SUMMARY OF THE INVENTION

The present invention is intended to overcome the above described disadvantages of conventional techniques.

Therefore it is an object of the present invention to provide a common music composition method and a system for the same utilizing the internet, in which any one of the general song components such as song words, melody and background melody is sent through a server, and the rest of the composition components are received so as to openly evaluate them, thereby commonly creating the songs.

It is another object of the present invention to provide a common music composition method and a system for the same utilizing the internet, in which the songs completed by using song words, melody and background melody are evaluated by disc agencies at the sites so as not only to match the music composers to the disc companies but also to make novices enable to evaluate their own creations.

It is still another object of the present invention to provide a common music composition method and a system for the same utilizing the internet, in which competent novice composers can be excavated and grown, and diversified songs can be openly publicly procured from the reserve music composers.

In achieving the above objects, the music composition method using the internet according to the present invention includes the steps of: inputting a connection request from a client PC, selecting a particular component from the requisite data such as song words, melody and background melody from a server, and outputting a data of the requested music component by the server to the client PC (first step); displaying the music component for the requested one of the client PC onto a screen (second step); inputting a data of the music component created by the user through the client PC (third step); and synthesizing the user-selected music component with the music data of the third step (fourth step).

In another aspect of the invention, the present invention is characterized in that the music components such as song words, melodies and background melodies are created for respective composition themes and rhythms to be stored in the server in advance, and new song words, melodies or background melodies are uploaded.

In still another aspect of the present invention, the song words, melodies and background melodies are stored in the client PC, and can be reproduced at an offline to be referred for composing a music.

In still another aspect of the present invention, the music components other than the requested one can be inputted through a keyboard, can be stored in a digital voice file, can be stored on various audio recording media, and can be inputted through a wire or wireless phone in a form of voice recording.

In still another aspect of the present invention, the music composition system including a plurality of client PCs connected through the internet, and a server for processing many requests from the plurality of the client PCs according to the present invention includes: an interface 41 for data transmissions to and from the client PC; a control module 43 for processing a data from the interface 41 and for outputting it;

In still another aspect of the present invention, the music composition system according to the present invention selectively includes: a composition data storing database 42 for storing in advance a requisite data such as song words, melodies and background melodies, and for storing a creation data from one of the client PCs; a conversion module 44 for converting the creation data from the one of the client PCs under a control of the control module; and a synthesizing module 45 for synthesizing the creation data (which is converted by the conversion module 44) and the requisite data together.

In still another aspect of the present invention, the music composition system according to the present invention selectively includes: a play module included in the synthesizing module for outputting a completed song through a speaker; another conversion module for converting a voice-recorded creation data after its inputting from one of the client PCs.

In still another aspect of the present invention, the music composition system according to the present invention includes: a receiving module connected to the interface, for storing the voices inputted from a hand phone, an IMT2000 or the like.

### BRIEF DESCRIPTION OF THE DRAWINGS

The above objects and other advantages of the present invention will become more apparent by describing in detail the preferred embodiment of the present invention with reference to the attached drawings in which:

FIG. 1 is a schematic illustration of the internet communication network to which a server and a plurality of client PCs are connected;

FIG. 2 is a flow chart showing the method of the present invention;

FIG. 3 is a flow chart showing the case where the background melody is selected as a composition component in the method of the present invention;

FIG. 4 is a block diagram showing the constitution of the system of the present invention;

FIG. 5 illustrates an example of picture display in the method of the present invention; and

FIG. 6 illustrates another example of picture display in the method of the present invention.

*Names of elements

| | | | |
|---|---|---|---|
| 10. | Client PC | 20. | Client PC |
| 30. | Client PC | 40. | Server |
| 41. | Interface | 42. | Composition data storing database |
| 43. | Control module | 44. | Conversion module |
| 45. | Synthesizing module | 46. | Play module |
| 47. | Speaker | 48. | Receiving module |
| 50. | Server | 60. | Telephone station |
| 70. | Base station | 80. | Wire telephone |
| 90. | Portable phone | | |

### DETAILED DESCRIPTION OF THE PREFERRED EMBODIMENTS

Now the present invention will be described in detail referring to the attached drawings.

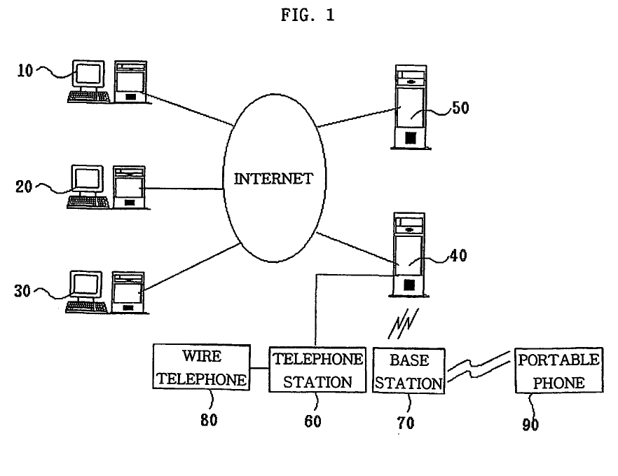

FIG. 1 is a schematic illustration of the internet communication network to which a server and a plurality of client PCs are connected.

As shown in this drawing, a plurality of client PCs 10, 20 and 30 and a plurality of servers 40 and 50 are connected through the internet. For the sake of describing convenience, it will be assumed that the server 40 is a music composition-furnishing server. The server can be connected and can serve not only through a wire telephone but also through internet and through a wireless communication terminal such as hand phone and the like.

The server 40 performs the role of assisting the completion of songs by utilizing the music component data such as song words, melodies and background melodies which have been stored in advance. The music component data such as song words, melodies and background melodies are created in advance, and newly created music data can be uploaded to a storage of the server so as to be added to the existing ones of the server 40. The uploading can be done by the conventional technique in an easy manner.

The music composition data such as song words, melodies and background melodies which have been stored in the server will be called “requisite data” while the data created by the user will be called “creation data”.

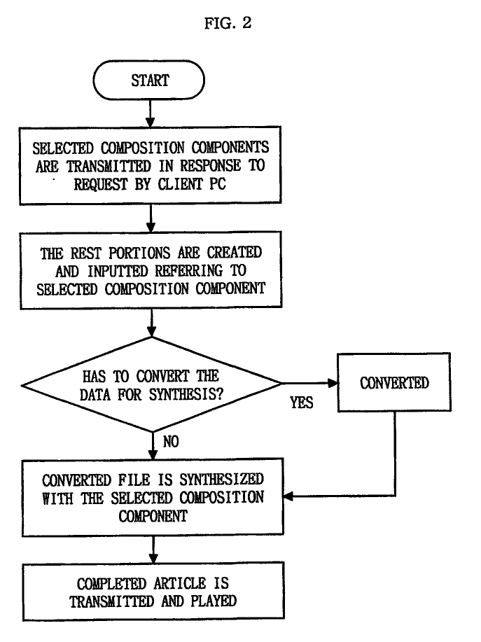

FIG. 2 is a flow chart showing the method of the present invention.

As shown in this drawing, the music composition method using the internet according to the present invention includes the steps of: inputting a connection request from a client PC, selecting a particular component from music components such as song words, melody and background melody from a server, and outputting a data of the requested music component by the server to the client PC; displaying the music components as requested by the user through the client PC onto a screen; inputting a data of the music component created by the user through the client PC; and synthesizing the user-selected music component with the music data of the third step.

The music composition components such as song words, melodies and the background melodies are prepared in advance and stored in the server so as to be utilized by users in creating their songs. One or more components of the requisite data can be furnished to the user. The user (who is a would-be composer) connects through the client PC to the server, and can select the desired components of the requisite data.

If the requisite data which have been selected by the user is outputted to the client PC, then the user completes the creation by utilizing the received requisite data. In other words, if the user selects song words from the requisite data, then the song words are outputted. Then the user creates a melody suitable to the received song words. In order to compose the melody, there are outputted the data such as music paper, musical scale and musical note. The creation data can be sent not only through online but also through offline.

If a creation data is inputted, the server synthesizes the creation data with the user-selected composition components. The creation data is furnished in a form of digital file from the client PC, and therefore, the synthesis is possible. If an audio file is inputted in a form of the conventional analogue file, then it is converted.

The conversion can be carried out by utilizing the conventional technique or by utilizing a self-prepared file format, and thus the synthesis can be carried out, thereby completing the music composition. The completed song can be transmitted to the client PC to be played there, or it may be disclosed to the subscribed members, so that its merits can be confirmed. This is the fifth step of the method of the present invention.

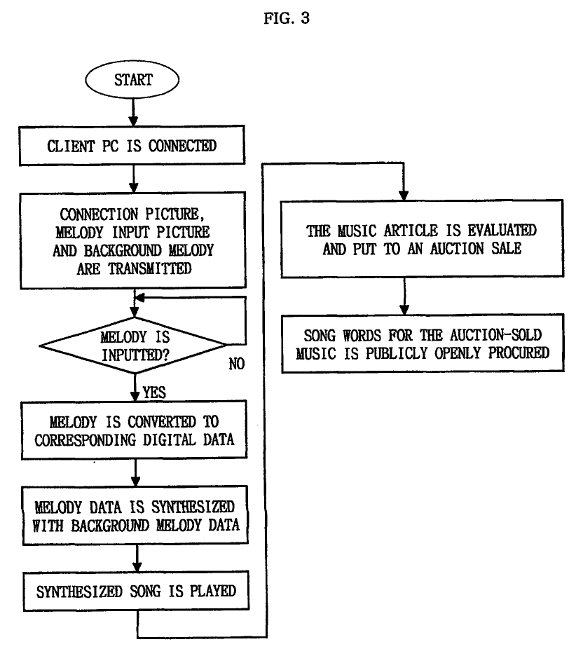

FIG. 3 is a flow chart showing the case where the background melody is selected as a composition component in the method of the present invention. The creation procedure is similar to that of FIG. 2, except the difference that the background melody is selected from the requisite data.

If a connection request is inputted from a client PC, then the server checks as to whether the user of the client PC is the normal subscriber (registered subscriber). This checking is based on the ID and the password like in the conventional method. If it is found the user is a registered member, then the server outputs a data for selecting a background melody and for displaying a melody.

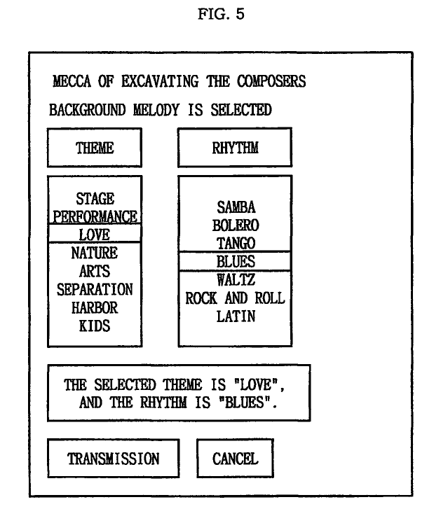

FIG. 5 illustrates an example of picture display in the method of the present invention. Here, there is a menu for selecting the background melodies. The background melodies to be selected are classified based on the composition themes and the musical rhythms. For example, the composition theme includes: love affairs, love, nature and the like. The musical rhythm includes: samba, bolero, tango, blues and the like. Not only the background melodies, but also the song words and the melodies are also prepared based on the composition themes.

The requisite data such as background melodies are composed in advance by professional composers, and thus are stored in the server 40 after being converted into an audio file format. The audio file format includes for example: wave, midi, MP3, real audio and the like. Of course, audio files which are to be developed in future can also be utilized. Further, the requisite data such as background melodies can be added more and can be uploaded.

The user who is connected through the client PC 10 to the server 40 selects the desired theme and rhythm, and transmits the selected details to the server 40. Under this condition, the details are display on the lower portion of the screen, so that the user can confirm the selected details. Upon receipt of the data from the user, the server 40 transmits the relevant background melody to the client PC 10.

After completion of the reception of the background melody from the server 40, the client PC 10 reproduces it based on the audio format by using a particular reproduction system.

For example, if the background melody belongs to the MP3 file format, then winamp or MS media is used to reproduce it. The reproduction is started by selecting the reproduction button on the picture. If the background melody is completely transmitted, the server 40 waits until the client PC 10 inputs a new melody as a creation data which has been created by utilizing the background melody of the server 40.

The user of the client PC inputs his or her own melody into the picture data which has been received from the server 40.

FIG. 5 illustrates an example of picture display in the method of the present invention. As shown in this drawing, there are illustrated the proceeding status of the background melody and a musical paper. The proceeding of the background melody should be preferably carried out at one or two segments, and in this connection, one or two segments should be displayed on the musical paper, so that the melody can be inputted.

The melody-inputting by the user may be carried out in various manners. For example, as shown in the lower portion of the picture, the respective keys of the keyboard are assigned to the respective key of a piano. Thus, the melody data can be inputted using the keys of the keyboard. That is, as shown in the drawing, the key assignment maybe such as C—do, D—re, E—mi, F—fa, G—sol, H—la, I—si, C—do, D—le, E—mi and so on.

Alternatively, the piano keys (not illustrated) are inputted into the menu picture, and these keys may be clicked by the mouse, thereby inputting the melody. This method is easy in inputting the melody compared with the key assignment method, but the inputting speed is slightly slow.

In still another method, the musical notes (not illustrated) such as rest note, sound note, beat selection, musical scale and the like are displayed in the picture. Then the musical notes are inputted using the mouse in a drag and drop method.

In still another inputting method, the user records his or her own voice, or performs using a musical instrument, and this is transmitted after converting it into an audio file format. For example, the transmission can be made by selecting the voice audio file in the input picture as shown in FIG. 5, or may be done by an e-mail.

In still another inputting method, the melody data is inputted through the 700-service by actual voice. In this case, the inputted voice melody data is first stored in the conventional form of tape record, and then, is converted into a digital audio file format. This method can be applied not only to the wire telephone but also to the wireless communication terminals such as hand phone, IMT200 and the like.

The melody data which has been inputted from the client PC 10 in the above method is stored by the server 40, and then, the server 40 converts the data into a digital audio data. That is, it can be converted into various audio file formats, but inmost cases, the melody data is converted into a file format which is same as that of the background melody.

In other words, the melody data which has been transmitted from the client PC 10 to the server 40 is converted into the same format as that of the background melody, but into anyone of wave, real media, MP3, WMA, AC3, and AAC.

After the melody data is converted into the audio file format, the melody data is synthesized with the background melody by the synthesizing module, thereby completing the musical composition data. The synthesizing module should be preferably capable of synthesizing all kinds of audio file formats including the above mentioned audio file format.

Further, the synthesizing module can be embodied with software depending on the processing speed of the server 40, but if it is embodied with hardware, then the sound synthesizing speed becomes faster. The synthesizing module may include a synthesizer.

When the musical composition data is completed, the musical composition data is outputted to the client PC 10. Upon receipt of the musical composition data, the client PC 10 reproduces the received musical composition data, and thus, the user of the client PC 10 can listen to the combination of his or her own melody and the background melody.

The user of the client PC can watch the received data through apparatuses having wireless protocols such as a digital HP, an IMT200, the PDA with a wireless communication interface, and the like. Further, if a caption player (which has both the caption and the audio functions) or a composite terminal (which consists of a combination of the caption player and a wireless communication terminal) is utilized, then the song and the song words can be simultaneously appraised. Accordingly, a more sure evaluation is possible.

In the present invention, there is disclosed a method for applying the music composition method to business. That is, the data same as those of the composition data which have been outputted from the server to the client PC are open to the server connectors (including the registered members and unregistered members), and thus the evaluation of the composed articles are collectively carried out, this being a fifth step of the method of the present invention. By opening the composition data to the registered members, there can be obtained the opinions of the plurality of the members, and thus, a more popular melody can be produced.

In the above described music composition method, if a melody of a would-be composer is adopted, a composition service company can grant a reward to him or her, while the relevant song words can be openly publicly invited for a prize.

If a music article which has been completed by the above described composition method is adopted by a disc manufacturing company, the composition right fee and the copyright fee can be divided at a certain ratio between the server managing company and the disc manufacturing company. This serves to connect novice composers to disc manufacturing companies.

Further, the server managing company may directly manufacture the discs. In this manner, competent novices can be excavated, and the disc manufacturing companies can also obtain nice music composition data. Further, the program for carrying out the method of the present invention should come within the scope of the present invention, while the medium for storing the program and the program-produced data should also come within the scope of the present invention.

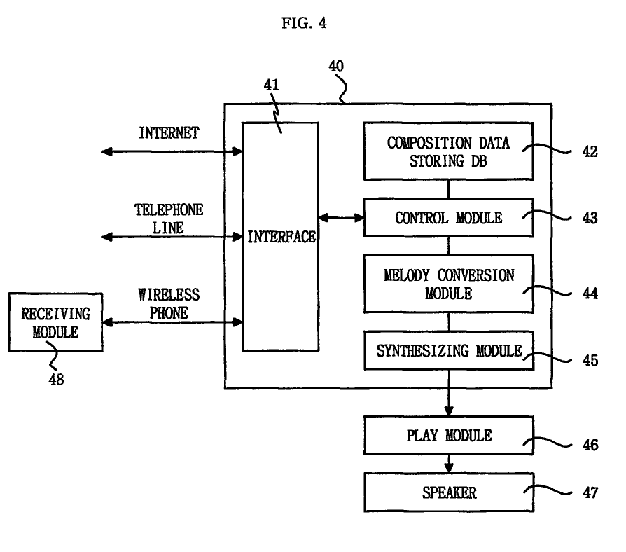

FIG. 4 is a block diagram showing the constitution of the server 40 of the present invention.

As shown in this drawing, the system of the server 40 includes: an interface 41 for transmitting/receiving the data to and from the client PCs; and a control module 43 for processing the data incoming from the interface 41, for outputting the processed data, and for storing the requisite data such as the song words, melodies, and background melodies.

The interface 41 carries out the transmission/reception of data to and from communication terminals such as the conventional internet, wire telephones, portable phones, IMT2000 and the like. In other words, the interface 41 is capable of carrying out the internet communications through a modem or an exclusive line, or through the modem and the telephone line. Further, the data communication is possible through a reception module 48 to and from the wireless communication terminals.

As for the wire telephone, if a melody data is inputted through the general home telephone line in the form of audio signals, then the server 40 stores the signals in a form of an audio file to carry out a conversion. In the cases of hand phones, PCS or IMT2000, there are stored the audio signals first, and then, a conversion is carried out.

In order to carry out this function, there are further included: a music composition data storing database 42 for storing the music composition data incoming from the client PCs; and a conversion module 44 for converting the creation data under the control of the control module 43 after its reception from one of the client PCs.

In the case where the melody is stored in voices, the melody has to be converted into musical beats and the musical notes on a musical paper. It is apparent that this can be easily done by the conventional technique.

Referring to FIG. 4, the control module 43 controls the data from the interface 41 suitably to the relevant purpose, and controls also the outputting data outputted through the interface 41. Thus the control module 43 carries out the overall control for the server 40.

If the client PC 10 makes a request for a connection, then the control module 43 outputs a necessary picture data. If the user's selection is a background melody, and thus if an output request for it is made, the control module 43 outputs the relevant background melody from the storage of the music composition data storing database 42 to the client PC 10. Further, if a melody is inputted from the client PC 10, then the control module 43 stores it into the music composition data-storing database 42.

The melody data either can be directly inputted into the picture, or can be inputted in the form of an audio to convert it into musical notes on the musical paper. The melody which has been expressed on the musical paper can be converted into an audio file format so as to be synthesized with the background melody.

The conversion module 44 is for converting the melody data of the music composition data-storing database 42 in accordance with the control signals of the control module 43.

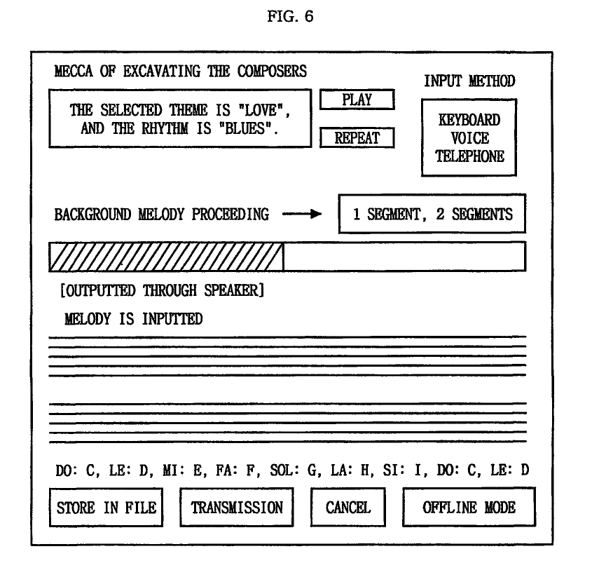

As shown in FIG. 6, the melody data is either directly inputted in the form of musical notes on a musical paper, or is inputted in the form of an audio, and then is converted into musical notes on a musical paper before being stored into the music composition data-storing database 42.

In order to convert the melodies, the conversion module 44 includes the modules for converting the melody data (transmitted from the client PC) to one of wave, midi, real audio, MP3, AAC, AC3 and WMA files.

The melody data which has been converted by the conversion module 44 is finally synthesized with the background melody by the synthesizing module 45. Thus a finally completed composition data is produced by the user by referring to the background melody.

The music composition data which has been produced finally by the synthesizing module 45 is transmitted back to the client PC 10. The transmitted data is played at the client PC 10, and the would-be composer can evaluate his or her own composition in an objective manner.

The synthesizing module 45 further includes a play module 46, so that the composition can be directly heard through a speaker 47. Thus the composed article can be evaluated in an objective manner. This is the case where the method of the present invention is applied to an event. That is, the music composition data can be heard on a real time basis, so that the composition data can be evaluated.

In the above descriptions, the requisite data was a background melody data, but the application will be same even in the case where the requisite data is a melody data. However, in the case where the requisite data is the song words, the processing becomes easier compared with the other cases. That is, the melody data or the background melody data of the user is synthesized with the song words in a simple manner, thereby completing a music creation.

Industrial Applicability

According to the present invention as described above, the background melody which is difficult to create by the general people can be easily obtained. Further, various melodies which have been inputted by many would-be composers can be synthesized with the background melodies instantly so as to evaluate them directly. Thus even novices can compose musical articles in an easy manner, and they can gain the evaluations on their creations in an objective manner. Further, competent new composers can be excavated and grown, and diversified music can be openly publicly procured from diversified would-be composers. Further, singers also can be matched to the relevant songs at the cybernetic space.

In the above, the present invention was described based on the specific preferred embodiments and the attached drawings, but it should be apparent to those ordinarily skilled in the art that various changes and modifications can be added without departing from the spirit and scope of the present invention, which will be defined in the appended claims.

What is claimed is:

1. A music composition method using the internet, comprising the steps of: inputting a connection request from a client PC, selecting a particular component from a requisite data such as song words, melody and background melody of a server, and outputting a data of the requested music component by the server to the client PC (first step); displaying the music component as requested by the client PC onto a screen (second step); inputting a data of the music component as created by the client PC (third step); and synthesizing the user-selected music component with the music data of the third step (fourth step).

2. The music composition method as claimed in claim 1, further comprising the step of: converting audio signals into a digital audio file format if the audio signals are present in the music composition data at the third step.

3. The music composition method as claimed in claim 1, wherein the requisite data is one or more selected from among song words, melody, and background melody.

4. The music composition method as claimed in any one of claims 1 and 3, wherein the requisite data is prepared in advance for different subjects, for different composition themes and for different rhythms, and are stored in a storing means of the server.

5. The music composition method as claimed in any one of claims 1 and 3, wherein the requisite data is supplemented with new requisite data by uploading it for different composition themes and for different rhythms.

6. The music composition method as claimed in claim 1, wherein melodies and background melodies of the requisite data are formed respectively into a digital audio file such as wave, midi, real audio, MP3, WMA, AC3 or AAC, and are stored.

7. The music composition method as claimed in claim 1, wherein a creation data from a client PC is converted into a digital file such as wave, midi, real audio, MP3, WMA, AC3 or AAC in a same manner as that of the requisite data, so as to be synthesized with the requisite data.

8. The music composition method as claimed in claim 1, wherein in inputting a melody data by a client PC at the third step, keys of a keyboard are assigned to keys of a piano, and these keys are inputted onto a musical paper in accordance with the melody data.

9. The music composition method as claimed in claim 8, wherein in inputting a melody data, piano keys are outputted onto a menu picture, and the piano keys are clicked with a mouse.

10. The music composition method as claimed in claim 8, wherein in inputting a melody data, symbols such as rest notes, sound notes, beat selection, musical scale selection and the like are displayed on the picture, and an inputting is carried out in a drag and drop method with the mouse.

11. The music composition method as claimed in claim 8, wherein in inputting a melody data, the user inputs his or her own voice suitably to the melody data.

12. The music composition method as claimed in claim 11, wherein in inputting a melody data, the user inputs the voices into a computer through a mike, converts the voices into a digital audio file, and transmits the file to the server.

13. The music composition method as claimed in claim 11, wherein in inputting a melody data, the user transmits a voice melody to the server through a wire telephone or a wireless communication terminal, and the server records it to extract musical notes on a musical paper.

14. The music composition method as claimed in claim 12, wherein in inputting a melody data, a digital audio file corresponding to a mike-inputted voice is transmitted to the server through a melody data inputting picture or an e-mail.

15. The music composition method as claimed in claim 1, wherein a data outputted from the server to the client PC is open to connection members, and evaluations of the members are collected, thereby forming a fifth step.

16. The music composition method as claimed in any one of claims 1 to 15, wherein if a completed creation music is adopted by a company, the relevant music composition company grants a prize to the composer.

17. The music composition method as claimed in claim 16, wherein the created music articles are referred to disc manufacturing companies and agencies through the internet to commercialize the articles.

18. The music composition method as claimed in claim 16, wherein the created music articles are referred to disc manufacturing companies and agencies to put the created articles to auctions.

19. The music composition method as claimed in any one of claims 16 to 18, wherein incomes earned are divided at a certain ratio between the service managing company and the composer.

20. The music composition method as claimed in any one of claims 16 to 18, wherein the created music articles are open within an enclosure of registered members so as to prevent the article from being stolen.

21. A music composition system comprising: a plurality of client PCs connected through the internet; a server for processing many requests from the plurality of the client PCs: an interface 41 for data transmissions to and from the client PCs; a control module 43 for processing a data from the interface 41 and for outputting it; a composition data-storing database 42 for storing in advance a requisite data such as song words, melodies and background melodies, and for storing a creation data from one of the client PCs; a conversion module 44 for converting the creation data from one of the client PCs under a control of the control module; and a synthesizing module 45 for synthesizing the creation data (which is converted by the conversion module 44) with the requisite data.

22. A storing medium for storing a program to carry out common music composition method through the internet, and for storing a data produced by the program.
